(19) United States
(12) Patent Application Publication
(10) Pub. No.: US 2009/0021167 A1
(43) Pub. Date: Jan. 22, 2009

(54) PLASMA DISPLAY PANEL AND MANUFACTURING METHOD THEREOF

(75) Inventors: Koji OHIRA, Miyazaki (JP); Tomohiko Murase, Miyazaki (JP); Minoru Fukui, Miyazaki (JP); Taisuke Yamamoto, Miyazaki (JP)

Correspondence Address: MILES & STOCKBRIDGE PC, 1751 PINNACLE DRIVE, SUITE 500, MCLEAN, VA, 22102-3833, US

(73) Assignee: HITACHI, LTD.

(21) Appl. No.: 12/173,151

(22) Filed: Jul. 15, 2008

(30) Foreign Application Priority Data
Jul. 20, 2007 (JP) 2007-189083

(51) Int. Cl. H01J 17/49; H01J 9/39

(52) U.S. Cl. 313/582; 445/55

(57) ABSTRACT

A technology capable of preventing or suppressing a display defect in a PDP (detrimental effect due to local contamination of the display area caused by admixture of impurity gas at the time of introducing discharge gas) is provided. In a PDP, first barrier ribs and first phosphors formed between the first barrier ribs are provided so as to correspond to a display area. In a non-display area outside the display area, an air hole for evacuation from a discharge space and gas filling into the discharge space is provided in a part of an outer perimeter of the panel. Further, an area in which second phosphors having a property of absorbing impurity gas are formed is formed at a position between the display area and the air hole in a part of the non-display area, in particular, in a part of a dummy rib area.

### CROSS-REFERENCE TO RELATED APPLICATION

The present application claims priority from Japanese Patent Application No. JP 2007-189083 filed on Jul. 20, 2007, the content of which is hereby incorporated by reference into this application.

### TECHNICAL FIELD OF THE INVENTION

The present invention relates to a plasma display panel (PDP). In particular, it relates to gas (discharge gas) filling to a discharge space, phosphors, and others.

### BACKGROUND OF THE INVENTION

In the manufacture of PDP with a conventional technology, one of the important factors to stabilize discharge characteristics and suppress characteristic changes with time is to increase the purity of discharge gas filled in the panel. For this reason, in the PDP discharge gas filling process, the panel is heated while evacuating the inside of the panel to remove impurity gas inside the panel, and then the discharge gas is filled in the panel.

However, in this discharge gas filling method, discharge gas is introduced through an air hole and a tip tube for evacuating the inside of the panel. Therefore, impurity gas exhausted from the inside of the panel is sometimes absorbed onto an inner wall of the evacuation system and enters again the inside of the panel together with discharge gas when introducing the discharge gas. Consequently, a part of the display area (screen) near the air hole is locally contaminated by the impurity gas, thereby disadvantageously causing a display defect (unevenness of display).

To solve the problems due to the influences of the impurity gas, for example, the following conventional technologies have been adopted.

(1) That is, a barrier rib is disposed near the air hole and the tip tube for gas filling provided at a corner of the panel. This barrier rib is, for example, a dummy rib (barrier rib provided outside of a barrier rib of the display area), a sealing material and others.

For example, Japanese Patent No. 3564783 (Patent Document 1) discloses the structure in which a protective barrier for diverting a path (flow path) for evacuation and gas filling is provided near an air hole. In such a structure, however, a detrimental effect of inviting a display defect occurs when the shape of the protective barrier is varied, and a problem of increasing the number of manufacturing steps is caused.

(2) Further, a getter material (impurity-gas absorbing material) is added to the inside of the discharge space of the panel. For example, Japanese Patent Application Laid-Open Publication No. 11-329246 discloses the structure in which a getter material (absorbing material) is disposed in an evacuation tube (tip tube) connected to the panel, and the impurity gas is removed by activating the getter material. However, even in such a structure, some measures regarding the method of disposing the getter and the insufficient activation of the getter are required in order to stably achieve the effects of the getter.

### SUMMARY OF THE INVENTION

The above-described conventional technology has the following problems. In a PDP, although depending on the product, the area other than the display area (non-display area) on the panel is preferably as small as possible. Therefore, an air hole (tip tube) is disposed as close as possible to the display area, although not too close.

Consequently, in accordance with the distance between the display area (in particular, protective layer or others) and the air hole, a detrimental effect sometimes occurs near the air hole due to local contamination of a display area caused by the admixture of impurity gas at the time of introducing discharge gas.

Regarding the display defect, in detail, when the inside of the panel (discharge space) is evacuated through the air hole and the tip tube and discharge gas is introduced, the impurity gas may possibly enter the panel. As a result, the protective layer (MgO or the like) of the display area is affected by the impurity gas and the film quality of the protective layer is locally changed. Consequently, unevenness in voltage increase (unevenness of display) and others occur in some cases.

The present invention has been devised in view of the above-described problems, and an object of the present invention is to provide a technology capable of preventing or suppressing the display defect in a PDP (detrimental effect due to local contamination of the display area caused by the admixture of impurity gas at the time of introducing discharge gas).

The typical ones of the inventions disclosed in this application will be briefly described as follows. That is, in order to achieve the above object, the PDP according to the present invention is characterized by having the following structure.

In this PDP, basically, in a substrate structure that forms a discharge space, a group of electrodes, first barrier ribs, first phosphors and others are formed, by which a group of display cells and a display area formed thereof are configured. The group of electrodes includes, for example, display electrodes (first electrodes) extending in a first direction and address electrodes (second electrodes) extending in a second direction. The first barrier ribs have, for example, a strip shape extending in the second direction or a box shape extending in the first and second directions for partitioning the discharge space so as to correspond to the group of display cells. The first phosphors are phosphors of at least one color formed by, for example, coating between the first barrier ribs. Also, a hole portion (air hole) or a tube portion (tip tube) for evacuation from the discharge space and gas filling into the discharge space is provided near a part of an outer perimeter of the panel in a panel-filling area.

Further, the structure of the PDP is characterized in that second phosphors are locally formed by coating in a part of an area near the hole portion (tube portion) in a non-display area (an area of the discharge space corresponding thereto) outside the display area within the filling area. The second phosphor (an area corresponding thereto) is a phosphor of at least one color and has a function to absorb impurity gas and others instead of a function for the structure of the display cells of the display area. For example, the second phosphor (its area) is formed by coating between the second barrier ribs in a part of a dummy rib area (second barrier rib area) formed outside a first barrier rib area of the display area (in particular, inside a dummy rib partition space (cell structure)).

The PDP is configured of a pair of substrates that form the discharge space, and at least one of the substrates is provided with an air hole for evacuation and gas filling. Also, the barrier ribs partitioning the discharge space include first barrier ribs in the display area and second barrier ribs in the non-display area outside the display area. Further, in a part of the second barrier rib area in the non-display area located at a position between the display area and the air hole, second phosphors are formed outside the first phosphors in the display area. By this means, impurity gas mixed through the air hole at the time of introducing discharge gas is absorbed by the second phosphors.

With the structure described above, when admixture of impurity gas is present at the time of gas filling through the hole portion (tube portion) into the discharge space of the PDP, the impurity gas is absorbed (trapped) by the second phosphors. By this means, the display defect described above is prevented or suppressed.

Also, for example, in the second phosphors (their area), phosphors of the same one color are formed. For example, in the first phosphor area, phosphors of plural colors (for example, red (R), green (G), blue (B)) are sequentially and repeatedly formed so as to be distinguished from each other. Meanwhile, in the second phosphor area, phosphors of one color (for example, R phosphors) whose specific surface area (surface area exposed to the discharge space) is the largest among the plural colors of the first phosphors are formed.

Alternatively, for example, phosphors of plural colors are formed in the second phosphors (their area). For example, in the first phosphor area, phosphors of plural colors (for example, red (R), green (G), blue (B)) are sequentially and repeatedly formed so as to be distinguished from each other. In the second phosphor area, phosphors of the same plural colors as those of the first phosphors are formed.

Still further, for example, the second phosphor area is formed in a part of an area adjacent to a position in the display area where the impurity gas is to be treated. Still further, the second phosphor area is formed in a band shape so as to correspond to one side of the display area. Alternatively, the second phosphor area is formed in a symmetrical shape when viewed from a front side of the panel.

In a manufacturing method of a PDP, as a process of forming a second phosphor area, the second phosphors are formed in a target area which is a part of the non-display area (second barrier rib area or others) by the screen printing method or the like using phosphorous paste and a print mask (phosphorous mask pattern) having an opening pattern corresponding to the phosphor area formed therein.

When the same phosphors are used for the first and second phosphors (their areas), at least a part of the processes thereof is performed in common, and a process of forming the second phosphor area is achieved as a simultaneous or successive (extended) process of a process of forming the first phosphor area. More specifically, compared with the conventional manufacturing method, the mask pattern in the formation of the first and second phosphors is used in common or is slightly changed for use.

The effects obtained by typical aspects of the present invention will be briefly described below. According to the present invention, the display defect in a PDP (detrimental effect due to local contamination of the display area caused by the admixture of impurity gas at the time of introducing discharge gas) can be prevented or suppressed, and thus a high-quality PDP can be provided.

Also, the present invention relates to a structure and a manufacturing method thereof in which second phosphors are formed for solving the problem due to the impurity gas. Further, with respect to the conventional technologies, since the material and the print mask are used in common, and no major process is newly added and only a little change is required, the structure and the manufacturing method thereof can be achieved at low cost.

### BRIEF DESCRIPTIONS OF THE DRAWINGS

These and other features, objects and advantages of the present invention will become more apparent from the following description when taken in conjunction with the accompanying drawings wherein:

FIG. 1 is a view showing a planar structure of a PDP according to an embodiment of the present invention (first structure example of a second phosphor area);

FIG. 2 is an exploded perspective view showing an example of a partial cross-sectional structure of the PDP according to an embodiment of the present invention;

FIG. 3 is a plan view showing a portion including an air hole in a planar structure of the PDP according to an embodiment of the present invention in an enlarged manner;

FIG. 4 is a view showing a planar structure of the PDP according to an embodiment of the present invention (second structure example of the second phosphor area);

FIG. 5 is a view showing a planar structure of the PDP according to an embodiment of the present invention (third structure example of the second phosphor area);

FIG. 6 is a view showing a planar structure of the PDP according to an embodiment of the present invention (fourth structure example of the second phosphor area); and

FIG. 7 is a view showing a planar structure of the PDP according to an embodiment of the present invention (fifth structure example of the second phosphor area).

### DESCRIPTIONS OF THE PREFERRED EMBODIMENTS

### PDP

### Plan View

Hereinafter, embodiments of the present invention will be described in detail with reference to the accompanying drawings. Note that components having the same function are denoted by the same reference numbers throughout the drawings for describing the embodiments, and the repetitive description thereof will be omitted.

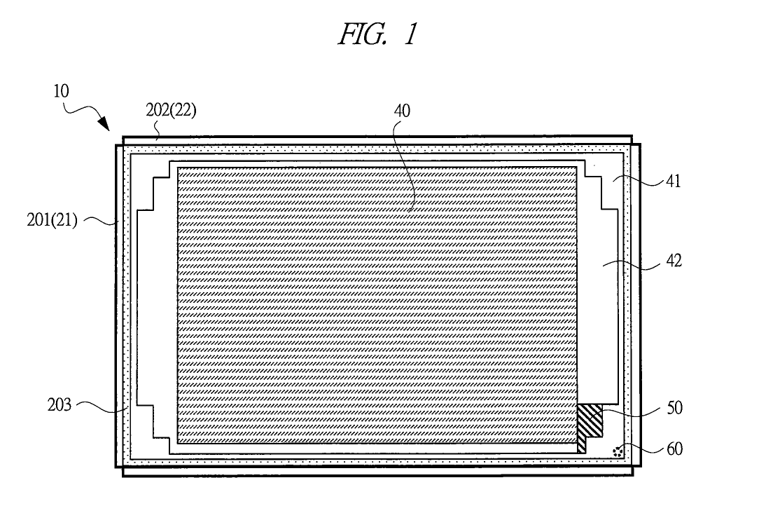

FIG. 1 shows an external appearance of a PDP according to an embodiment of the present invention (first structure example), that is, a planar structure thereof seen from a front surface side. A PDP (panel) 10 is completed by combining the structures (first substrate structure 201 and second substrate structure 202) of a first substrate (front glass substrate) 21 and a second substrate (rear glass substrate) 22 in a state of being faced with each other, sealing them with frit (sealing material) to be a sealing area 203, performing evacuation of the inside of the panel (area to be discharge space) via an air hole 60, and then introducing discharge gas and sealing the air hole 60.

The air hole 60 is formed inside the sealing area 203, for example, at one position in a marginal portion of the structure of the second substrate 22 on the panel rear side, that is, at a lower-right corner in this example. The air hole 60 can be provided at any position between a display area 40 and the sealing area 203. One end of a tip tube is attached to the air hole 60. The other end of the tip tube is connected to an external device. An area for the electrical connection between terminals of the group of the electrodes and external drive circuits is provided outside the sealing area 203.

The rectangular display area (screen) 40 of the group of the display cells occupies the most part of a front surface area of the panel. A non-display area 41 outside the display area 40 has a dummy rib area (dummy area, second barrier rib area) 42. Further, an area of second phosphors (dummy phosphors) 50 is provided in a part of the dummy rib area 42 between the display area 40 and the air hole 60.

Note that the external appearance of the PDP in the conventional technologies is similar to that shown in FIG. 1 but the dummy phosphors 50 are not provided.

### PDP

### Cross Section

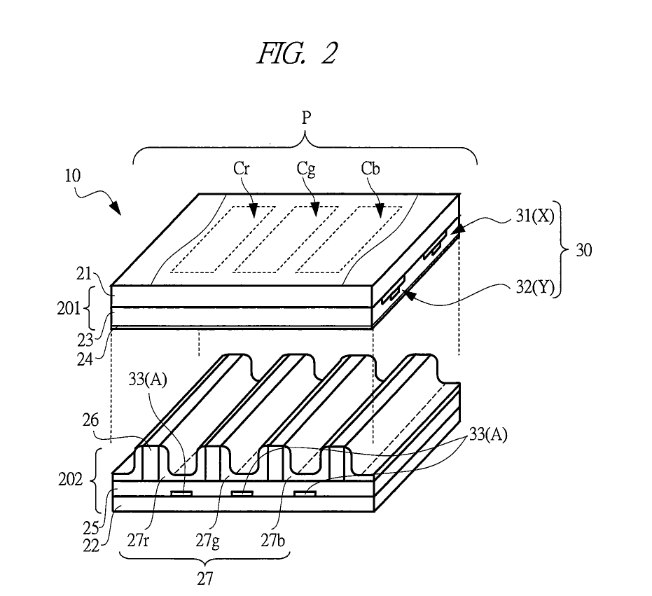

FIG. 2 shows a part corresponding to a display cell (pixel) as an example of a basic structure of the PDP according to the present embodiment.

In the first substrate structure 201, the first substrate (front glass substrate) 21 is provided with a group of display electrodes (first electrodes) 30 extending approximately in parallel in a first direction (lateral direction). The display electrodes 30 are, for example, sustain electrodes (X) 31 and scan electrodes (Y) 32. A plurality of pairs of the display electrodes 30 (31, 32) are provided in accordance with the number of display lines and the number of display cells in a second direction (longitudinal direction). On the first substrate 21, a dielectric layer 23 is provided to cover the group of display electrodes 30. Furthermore, a protective film (protective layer) 24 is provided on the surface of the dielectric layer 23. The protective film 24 is provided on the entire surface correspondingly to the display area 40 and is exposed to the discharge space, and thus it is affected by the impurity gas.

In the second substrate structure 202, the second substrate (rear glass substrate) 22 is provided with a group of address electrodes (second electrodes) 33 extending approximately in parallel in the second direction (longitudinal direction). On the second substrate 22, a dielectric layer 25 is provided to cover the group of address electrodes 33. On the dielectric layer 25, barrier ribs (first barrier ribs) 26 are provided on both sides of each of the address electrodes 33. For example, the barrier ribs 26 are formed in a strip shape extending in the second direction. Alternatively, the barrier ribs 26 are formed in a box shape extending in the first and second directions. On the side surfaces of each barrier rib 26 and on the dielectric layer 25 between the substrates, phosphors (first phosphors) 27 (27r, 27g, 27b) of red (R), green (G), and blue (B) are successively and repeatedly formed for each display line. A plurality of sets of these phosphors 27 (27r, 27g, 27b) are provided in accordance with the number of pixels (P) in the first direction.

Also, for example, the first substrate 21 has a thickness of approximately 2 to 3 mm. Meanwhile, the dielectric layer 23 has a thickness of several tens of μm and the protective film 24 has a thickness of approximately 1 μm. Therefore, the first substrate 21, the group of the display electrodes 30, the dielectric layer 23, the protective film 24, and others are collectively referred to as a first substrate in some cases.

Furthermore, for example, the second substrate 22 has a thickness of approximately 2 to 3 mm. Meanwhile, the dielectric layer 25 has a thickness of several tens of μm and each of the barrier ribs 26 has a thickness of 100 to 200 μm. Therefore, the second substrate 22, the group of the address electrodes 33, the dielectric layer 25, the barrier ribs 26, the phosphors 27, and others are collectively referred to as a second substrate in some cases.

<Area>

Definitions of respective areas such as the display area 40 in this specification are as follows. An image is displayed on the PDP by applying a voltage to the group of display electrodes to generate the discharge (sustain discharge), and the area where the light emission by the discharge (or light emission from the phosphors excited by the discharge) occurs, in other words, the area where the display by the lighting/non-lighting of the display cells can be performed is referred to as the display area 40. Also, the area outside the display area 40 where no display is performed (or the area that is not used even through the display can be performed) is referred to as the non-display area 41.

Also, the area in the non-display area 41 that is formed successively with the area of the barrier ribs (first barrier ribs) 26 in the display area 40 but is not used for display is referred to as the dummy rib area (second barrier rib area) 42. The non-display area 41 is assumed to be provided inside the sealing area 203.

The phosphors (phosphor area) formed in the display area 40 for the original purpose of displaying are referred to as first phosphors (27), and the phosphors formed in a part of the non-display area 41 for the purpose of absorption (getter), which is a feature of the present invention, are referred to as second phosphors (50).

<Phosphor (1)>

The first structure example of the PDP 10 in FIG. 1 is characterized in that the second phosphors 50 are formed by coating inside a part of the dummy rib area adjacent to the air hole 60, for example, inside a partition space (cell pattern) defined by the dummy rib area 42. With this structure, the impurity gas mixed through the air hole 60 at the time of introducing the discharge gas can be absorbed (trapped) by the second phosphors 50. By this means, the occurrence of a display defect can be prevented or suppressed.

The area where the second phosphors 50 are formed is between the display area 40 and the air hole 60 and near a position where the influence due to the impurity gas in the display area 40 is to be addressed. In this example, the area of the second phosphors 50 is a small area in the dummy rib area 42 on the right side of the lower-right corner of the display area 40.

The formation by coating of the second phosphors 50 onto a target area of the dummy rib area 42 can be easily achieved by the conventionally-utilized screen printing method. A print mask pattern of the phosphors is designed so that the phosphors can be coated on the target area of the dummy rib area 42. The structure and formation process of the second phosphors 50 can be achieved without any addition of new process and with a little change with respect to the conventional technologies, and an improvement can be achieved by addressing the influences due to the impurity gas. Also, the shape of the area of the second phosphors 50 formed by coating on the target area can be arbitrarily set in accordance with the print mask pattern of the phosphors. The area of the second phosphors 50 can be designed in accordance with the patterns of the dummy rib area 42 and the barrier ribs, the position of the air hole 60, and others formed in the non-display area 41.

<Enlarged View>

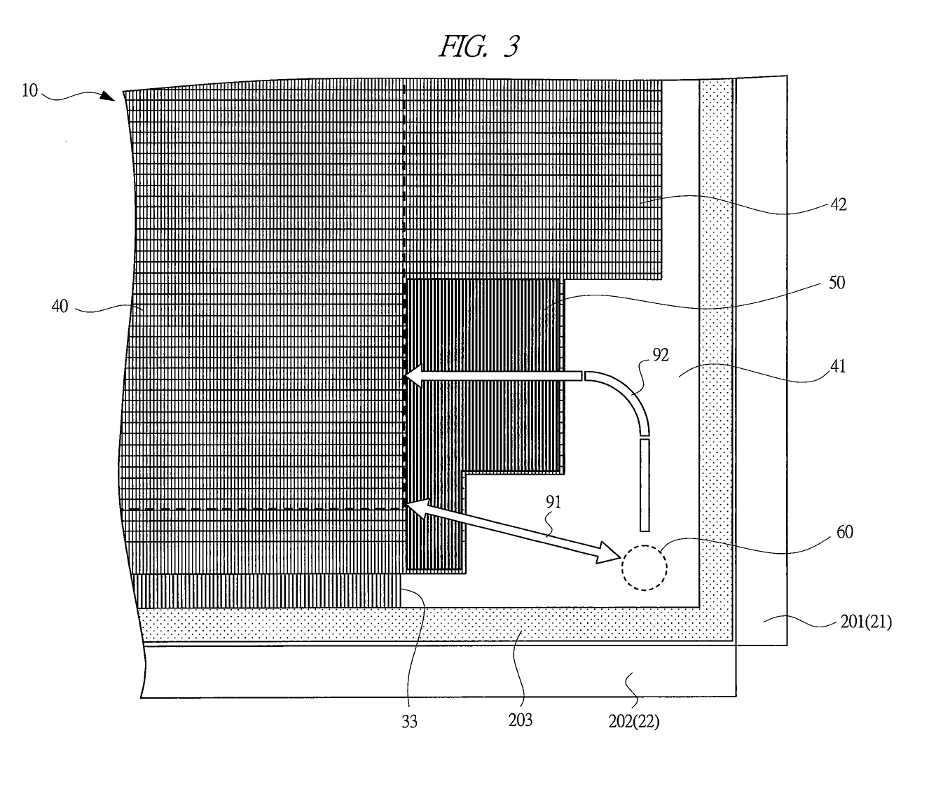

FIG. 3 shows an enlarged view of the lower-right corner of the panel including the air hole 60 correspondingly to the first structure example of the area of the second phosphors 50 in FIG. 1. Although this drawing shows the case where the barrier ribs (26, 42) are formed in a box shape, the same goes for the case where the barrier ribs are formed in a strip shape.

As an example of a path (gas flow path) between the air hole 60 and the display area 40, a path 91 shows a path between the air hole 60 and the lower-right corner of the display area 40 positioned nearest to the air hole 60. The second phosphors 50 are formed on a part of the path 91.

Also, a path 92 shows an example of a path that is longer than the path 91 and goes around from the upper side of the air hole 60 to reach the right side of the display area 40. The second phosphors 50 are formed also on a part of the path 92. In detail, the structure of the paths and the degree of the influences of impurity gas on the display area 40 (for example, the protective film 24) depend not only on the length of the paths but also on the shape of the structure of the dummy rib area 42 of the non-display area 41 between the substrates. In consideration of these factors, the shape of the area of the second phosphors 50 can be designed.

<Phosphor (2)>

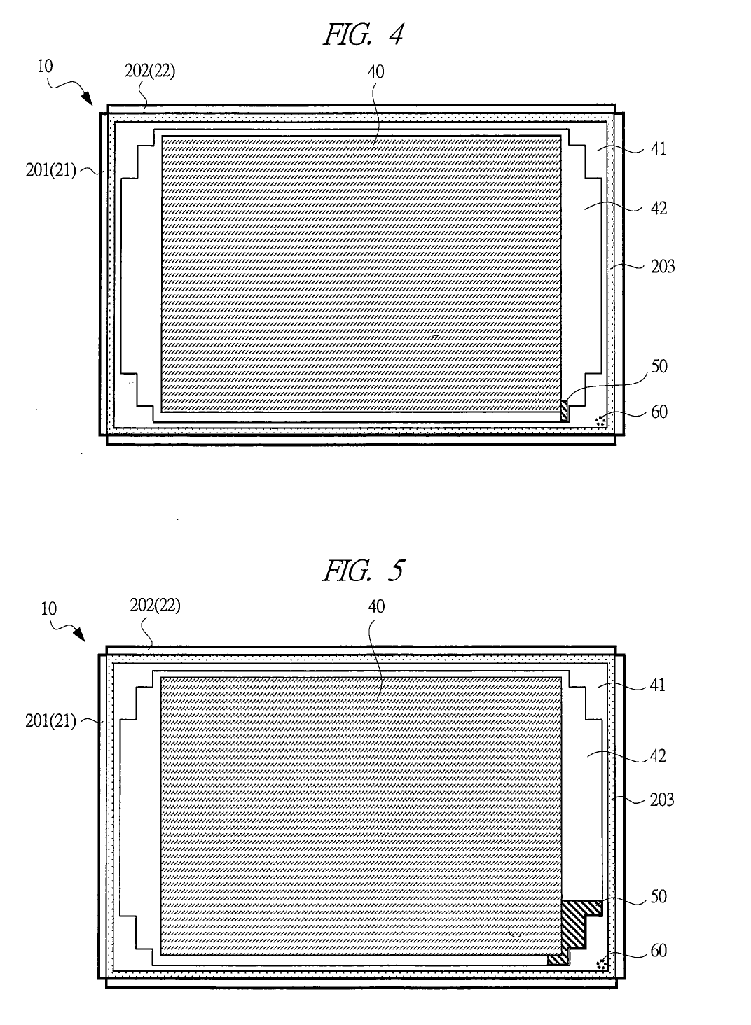

FIG. 4 shows a modification example (second structure example) of the shape of the area of the second phosphors 50 formed in the dummy rib area 42. In this structure, the area of the second phosphors 50 is provided in a small rectangular shape next to the right side of the lower-right corner of the display area 40. The second phosphors 50 are provided at minimum only on the path 91 between the lower-right corner of the display area 40 and the air hole 60.

<Phosphor (3)>

Similarly, FIG. 5 shows a third structure example of the area of the second phosphors 50. In this structure, the area of the second phosphors 50 is provided in the dummy rib area 42 near the lower-right corner of the display area 40 so as to include a portion next to the right side of the display area 40 and a portion next to the lower side of the display area 40 and surround the air hole 60 to some extent.

<Phosphor (4)>

Similarly, FIG. 6 shows a fourth structure example of the area of the second phosphors 50. In this structure, the second phosphors 50 are formed on the right side of the display area 40 corresponding to the air hole 60 in a band-shaped area vertically continuing in the dummy rib area 42. In this case, compared with the case where the second phosphors 50 are locally formed at a corner of the panel as shown in FIG. 4 and FIG. 5, a boundary of the presence or absence of the second phosphors 50 in the dummy rib area 42 is inconspicuous when viewed from the front side of the panel. Therefore, the effect of solving the problem due to the impurity gas can be achieved without impairing the quality of external appearance.

<Phosphor (5)>

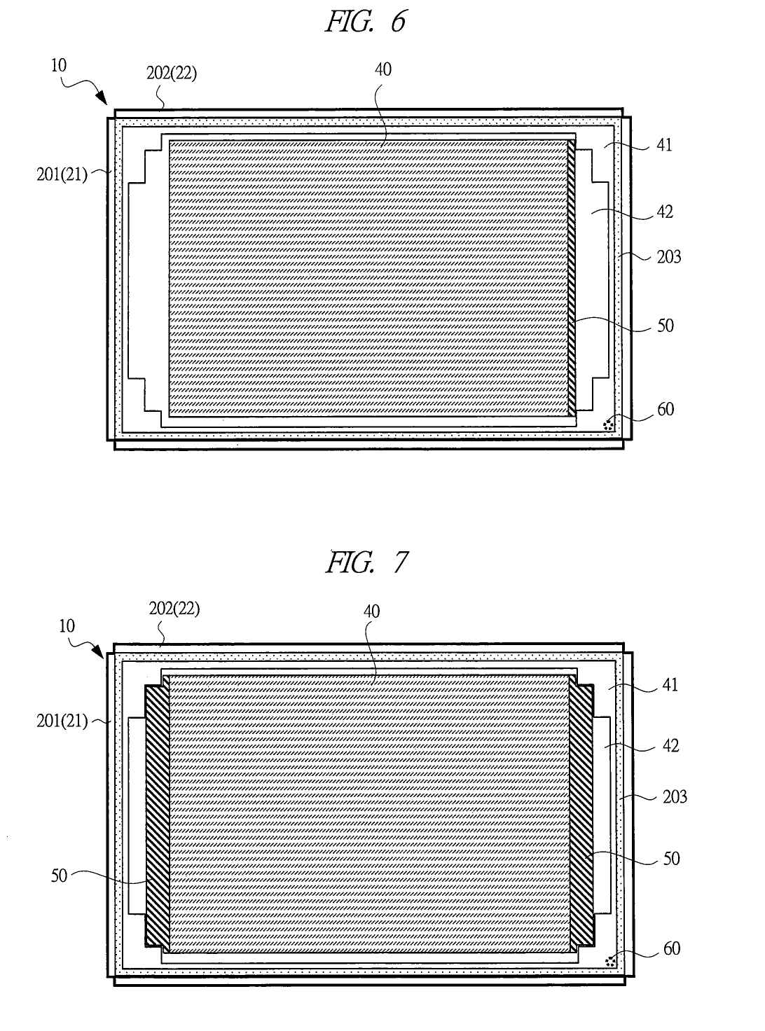

Similarly, FIG. 7 shows a fifth structure example of the area of the second phosphors 50. In this structure, the area of the second phosphors 50 is formed in an approximately rectangular shape vertically continuing on the right and left sides of the display area 40, not only on the side where the air hole 60 is present. In other words, the areas of the second phosphors 50 are symmetrically formed when viewed from the front surface of the panel. In this structure, an emphasis is placed on the symmetry in external appearance of the panel, and an effect of not impairing the quality of external appearance can be achieved.

Note that, with regard to the structures where external appearance is taken into consideration as shown in FIG. 6 and FIG. 7 and those where external appearance is not taken into consideration, for example, when the non-display area 41 is hidden by a casing or the like when viewed from the front side, the effect for the external appearance may not be taken into consideration.

<Manufacturing Method>

Next, a manufacturing method of the PDP 10, in particular, a method of forming the areas of the first and second phosphors (27, 50) will be described below. The second phosphors 50 formed by coating in the target area of the dummy rib area 42 are assumed to be phosphors of one color (for example, R phosphors), phosphors of two colors, or phosphors of three colors (R, G, B phosphors). In the formation of the areas of the first and second phosphors (27, 50), the efficiency can be improved by using at least a part of the colors of the phosphors and at least a part of the processes in common.

Examples of a method of forming the first and second phosphors (27, 50) using the screen printing method are as follows. (1) A print mask similar to a conventional one to be used for the area of the first phosphors 27 is similarly applied to the formation of the area of the second phosphors 50. (2) A print mask changed from a conventional one, which is extended so as to include not only the area of the first phosphors 27 but also the area of the second phosphors 50, is used. (3) A print mask dedicated for the area of the second phosphors 50 is used separately from a print mask for the area of the first phosphors 27.

With the method (1) or (2), in the area of the second phosphors 50, similarly to the area of the first phosphors 27, phosphors of three types of R, G and B are sequentially and repeatedly formed for each color. Alternatively, in the area of the second phosphors 50, unlike the area of the first phosphors 27, phosphors of one of three types of R, G and B are formed.

When the second phosphors 50 are formed to have the same structure as that of the first phosphors 27 in the display area 40, in other words, when the area of the second phosphors 50 is formed by coating a target area with phosphors of three colors of R, G, and B sequentially for each display line, the same print mask can be used in common for the formation of each of the three colors. Specifically, R portions of the first and second phosphors (27, 50) are simultaneously or successively formed by using a mask for R phosphors, and then G phosphors and B phosphors are formed sequentially in the same manner.

On the other hand, when the second phosphors 50 are formed to have the structure different from that of the first phosphors 27 in the display area 40, in other words, when the area of the second phosphors 50 is formed by coating a target area with one color (R phosphors), two types of print masks such as that for the formation of the area of the first phosphors 27 and that for the formation of the area of the second phosphors 50 are required. Specifically, a first type of mask is used to form the area of the first phosphors (27r, 27g, 27b) and then a second type of mask is used to form the area of the second phosphors 50. For example, R phosphors (27r) of the first phosphors 27 and R phosphors of the second phosphors 50 are simultaneously or successively formed. Alternatively, after the area of the first phosphors (27r, 27g, 27b) is formed, the R phosphors of the second phosphors 50 are formed.

Since the main function of the second phosphors 50 is to absorb impurity gas, a phosphorous material (for example, phosphorous paste) with a high absorptivity of impurity gas is preferably used. Therefore, the effect can be further enhanced by selecting and using the phosphors with the highest absorptivity among the R, G, and B phosphors 27 (27r, 27g, 27b) used for the display area 40.

In the above-described embodiments, the highest absorptivity can be obtained when the R phosphors 27r with the largest specific surface area are formed as the second phosphors 50. Note that the specific surfaces areas of the phosphors of the respective colors at that time are approximately R:G:B=2:1:1.

<Phosphor Materials>

In the present embodiment, the phosphor materials for use as first and second phosphors (27, 50) are as follows.

R phosphor (27r) . . . (Y, Gd) BO₃:Eu

G phosphor (27g) . . . Zn₂SiO₄:Mn

B phosphor (27b) . . . BaMgAl₁₀O₁₇:Eu

As described above, according to each of the embodiments, since the impurity gas is absorbed by the second phosphors 50, influences on the display area 40 are suppressed, and thus the occurrence of a display defect can be prevented. Also, since these embodiments can be achieved with only a little change of the conventional manufacturing method, the solution of the problem due to the impurity gas can be achieved at low cost.

In the foregoing, the invention made by the inventors of the present invention has been concretely described based on the embodiments. However, it is needless to say that the present invention is not limited to the foregoing embodiments and various modifications and alterations can be made within the scope of the present invention.

What is claimed is:

1. A plasma display panel in which a display area of a group of display cells is configured in a substrate structure having a group of electrodes and a discharge space formed therein, the plasma display panel comprising:
first barrier ribs that partition the discharge space correspondingly to the group of the display cells and first phosphors formed between the first barrier ribs, the first barrier ribs and the first phosphors being formed correspondingly to the display area;
a hole portion for evacuation from the discharge space and gas filling into the discharge space, the hole portion being formed in a non-display area outside the display area; and
an area in which second phosphors having a property of absorbing impurity gas are formed at a position between the display area and the hole portion in the non-display area.

2. The plasma display panel according to claim 1,
wherein the non-display area has an area of second barrier ribs successively formed outside the first barrier ribs, and
the second phosphors are formed between the second barrier ribs in a part of the area of the second barrier ribs.

3. The plasma display panel according to claim 1,
wherein, in the area of the second phosphors, phosphors of one color are formed.

4. The plasma display panel according to claim 3,
wherein, in an area of the first phosphors, phosphors of plural colors are sequentially and repeatedly formed so as to be distinguished from each other, and
in the area of the second phosphors, phosphors of one color whose specific surface area is largest among the plural colors of the first phosphors are formed.

5. The plasma display panel according to claim 1,
wherein, in an area of the first phosphors, phosphors of plural colors are sequentially and repeatedly formed so as to be distinguished from each other, and
in the area of the second phosphors, phosphors of the same plural colors as those in the area of the first phosphors are sequentially and repeatedly formed so as to be distinguished from each other.

6. The plasma display panel according to claim 1,
wherein the area of the second phosphors is formed in a band shape correspondingly to one side of the display area.

7. The plasma display panel according to claim 1,
wherein the area of the second phosphors is formed in a symmetrical shape viewed from a front side of the panel.

8. A manufacturing method of a plasma display panel in which a display area of a group of display cells is configured in a substrate structure having a group of electrodes and a discharge space formed therein, the plasma display panel comprising:
first barrier ribs that partition the discharge space correspondingly to the group of the display cells and first phosphors formed between the first barrier ribs, the first barrier ribs and the first phosphors being formed correspondingly to the display area; and
a hole portion for evacuation from the discharge space and gas filling into the discharge space, the hole portion being formed in a non-display area outside the display area, and
the method comprising the step of: forming second phosphors having a property of absorbing impurity gas at a position between the display area and the hole portion in the non-display area.

9. The manufacturing method of a plasma display panel according to claim 8, further comprising the steps of:
successively forming an area of second barrier ribs outside the first barrier ribs in the non-display area; and
forming the second phosphors between the second barrier ribs in a part of the area of the second barrier ribs.

10. The manufacturing method of a plasma display panel according to claim 8,
wherein, in an area of the second phosphors, phosphors of one color are formed.

11. The manufacturing method of a plasma display panel according to claim 10, further comprising the steps of:
sequentially and repeatedly forming phosphors of plural colors so as to be distinguished from each other in an area of the first phosphors, and
subsequent to the step of forming the first phosphors, forming phosphors of one color whose specific surface area is largest among the plural colors of the first phosphors in the area of the second phosphors.

12. The manufacturing method of a plasma display panel according to claim 8, further comprising the steps of:
sequentially and repeatedly forming phosphors of plural colors so as to be distinguished from each other in an area of the first phosphors, and
subsequent to the step of forming the first phosphors, sequentially and repeatedly forming phosphors of the same plural colors as those in the area of the first phosphors so as to be distinguished from each other in an area of the second phosphors.

13. The manufacturing method of a plasma display panel according to claim 8,
wherein the second phosphors are formed by screen printing using a print mask having an opening pattern corresponding to an area of the second phosphors.
